(19) United States
(12) Patent Application Publication
(10) Pub. No.: US 2026/0091556 A1
(43) Pub. Date: Apr. 2, 2026

(54) SYSTEM AND METHOD FOR PRODUCING REPLICA COMPONENTS WITH FUNCTIONAL CAPACITY BLOCKERS

(71) Applicant: Nicholas Bock, Eustis, FL (US)

(72) Inventor: Nicholas Bock, Eustis, FL (US)

(21) Appl. No.: 18/904,602

(22) Filed: Oct. 2, 2024

(51) Int. Cl. B29C 64/393; B33Y 50/02

(52) U.S. Cl. CPC B29C 64/393; B33Y 50/02

(57) ABSTRACT

A system and method for creating a replica component having a functional capacity blocker includes a system having a 3D scanner for scanning a first component, and a computer for controlling the operation of the scanner and for receiving data sets produced by the scanner. The computer including functionality for modifying the data set to include a functional capacity blocker. A database stores the modified 3D data set, and a 3D printer produces a replica component having the functional capacity blocker. When used to create replica aircraft components for use in a classroom environment, the functional capacity blocker prevents the replica component from being installed onto an aircraft.

### TECHNICAL FIELD

The present invention relates generally to the education industry, and more particularly to a system and method for producing fully accurate replica components with built in functional capacity blockers for educational purposes.

### BACKGROUND

The statements in this section merely provide background information related to the present disclosure and may not constitute prior art.

Many educational institutions such as universities and trade schools have courses dedicated to training students in the art of repairing and maintaining complex vehicles and machinery. For example, many aviation maintenance programs include a two-year comprehensive curriculum that teaches students to inspect, diagnose and repair a wide range of different aircraft types such as jet airplanes, propeller-driven airplanes, and helicopters, for example.

In this regard, it is well known that the more hands-on experience students can get working with physical aircraft components the better and quicker they are able to learn.

Unfortunately, aircraft components are extremely expensive to obtain, as even heavily used aircraft parts can cost tens of thousands of dollars to purchase. Moreover, as technology advances, many of these expensive components become obsolete quickly, thus limiting their useful lifespan in a classroom environment. As a result, many universities are unable to obtain sufficient numbers of relevant aircraft components for students to learn on. Indeed, it is not uncommon for a university to only have a handful of generic staple aircraft components such as flaps, rudders, landing gear, etc., that students can actually touch and see over their two years of training. This is not ideal, as a typical jet aircraft has over 50,000 individual components.

Accordingly, it would be beneficial to provide a system and method for producing non-functional replica components for use in classroom environments that can be created for a fraction of the cost of the respective airworthy components, so as to eliminate the drawbacks noted above.

### SUMMARY OF THE INVENTION

The present invention is directed to a system and method for creating a replica component having a functional capacity blocker. One embodiment of the present invention can include a system having a 3D scanner for scanning a first component, and a computer for controlling the operation of the scanner and for receiving data sets produced by the scanner. The computer can include functionality for modifying the data set to include a functional capacity blocker. A database can be provided for storing the modified 3D data set, and a 3D printer can be provided for producing a replica component having the functional capacity blocker.

In one embodiment, the system can be utilized to create replica aircraft components for use in a classroom environment and the functional capacity blocker can be provided to prevent the replica component from being installed onto an aircraft. In one embodiment, the replica components are produced by the platform provider and shipped to an end user. In one embodiment, an end user can selectively access the database to download and print the replica components on-site.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a system for producing a replica component with a functional capacity blocker that is useful for understanding the inventive concepts disclosed herein.

FIG. 2 is a flowchart illustrating an exemplary method for producing a replica component with a functional capacity blocker in accordance with one embodiment of the invention.

FIG. 3 is a perspective view of an exemplary first component scanned by the system of FIG. 1, in accordance with one embodiment of the invention.

FIG. 4 is a perspective view of an exemplary replica component produced by the system of FIG. 1, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described throughout this document, the term “about” “approximately” “substantially” and “generally” shall be used interchangeably to describe a feature, shape, or measurement of a component within a tolerance such as, for example, manufacturing tolerances, measurement tolerances or the like.

The term “platform provider” describes the individual, group or legal entity that is providing and/or overseeing the below described system in order to perform the methodology described herein.

As described herein, the term three-dimensional printer, 3D printer, or variants thereof can include any type of printing technologies and/or manufacturing methods to produce two-or three-dimensional components based on the inputs provided by an initial scan. For example, a 3D printer can include a printer that uses laminated object manufacturing, binder jetting, additive manufacturing, rapid prototyping, layered manufacturing, stereolithography, fused deposition modeling, or any other type of known 3D printing method, including the utilization of CNC and CNC milling devices. These techniques are well known to an artisan in the relevant arts.

Although described below with regard to utilizing the system and method to create replica aircraft components for use in a school or university setting, those of skill in the art will recognize that the inventive concepts described herein can be applied towards any type of component and can be used in any number of different industries and environments. As such, the inventive concepts are not to be construed as limiting.

As will be described below with respect to the figures, one embodiment of a system and method of providing fully accurate non-airworthy components for use in a classroom environment is provided. The system and method can include, essentially, acquiring a complete three-dimensional scan of a desired aircraft component, modifying the 3D data set to include a functional capacity blocker, storing the modified 3D data set on a central database, and selectively downloading and printing a replica component with the functional capacity blocker.

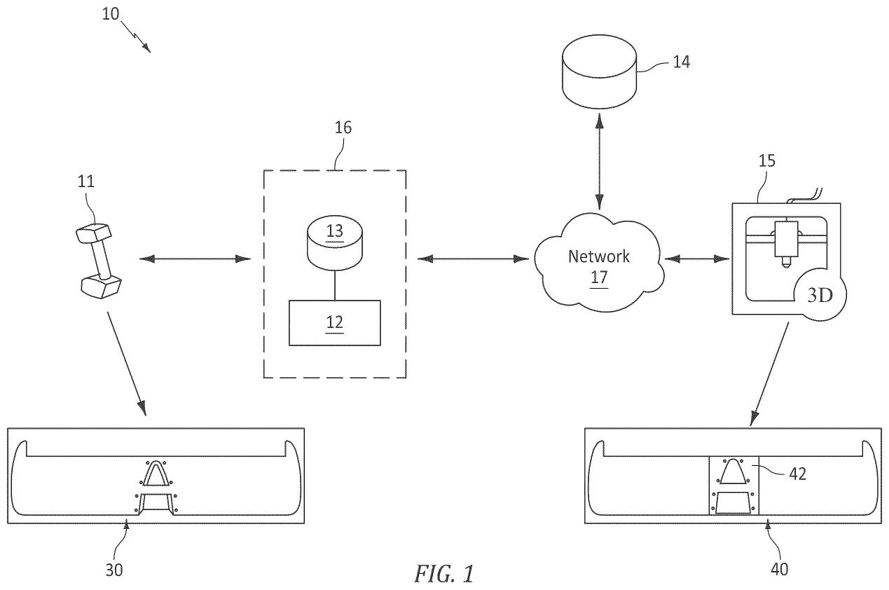

FIG. 1 illustrates one embodiment of a system 10 for producing a replica component with a functional capacity blocker. Various aspects of the system can be performed by a platform provider, and the system can include, essentially, a 3D scanner 11 that captures a complete three-dimensional scan of a component, such as the aircraft component 30, for example. The 3D data set captured by the scanner 11 can be processed by a processor 12 and can be stored on a data storage unit 13. Drafting and editing software on the processor and memory are used to edit the original 3D data set to include a functional capacity blocker, and the modified 3D data set can be stored in a database 14. As described herein, a database and a data storage unit can each include any type of computer-readable storage mediums, including all forms of volatile and non-volatile memory such as, for example, semiconductor memory devices, magnetic disks, magneto-optical disks, and optical disks.

The modified 3D data set can be used by a 3D printer 15 to create a replica component 40 having the functional capacity blocker 42 to ensure the component 40 is not mountable onto an aircraft but is otherwise an exact replica for use in a classroom environment.

In one embodiment, the processor 12 and data storage unit 13 are provided in a single electronic device 16 such as a computer or smartphone, for example, and each of the computer 16, database 14 and 3D printer 15 can be connected (either directly or via an intermediary computer) to a network 17, such as the internet and/or via a direct connection to each other, for example.

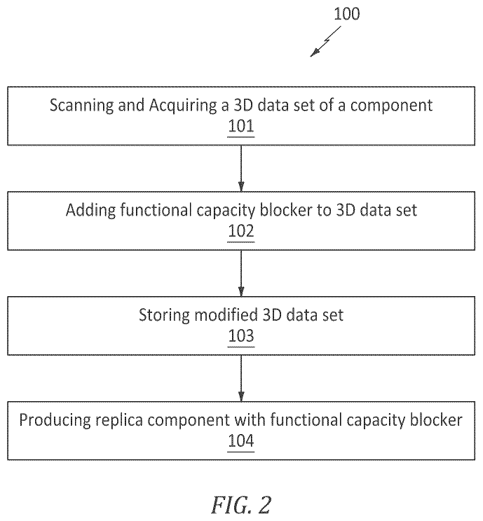

One embodiment of a process 100 for creating a replica component with a functional capacity blocker can include the following steps, which are generally illustrated in the flowchart of FIG. 2. Other features of the current embodiments will become apparent in the course of the following descriptions, which are given for illustration of the current embodiments, and are not intended to be limiting thereof.

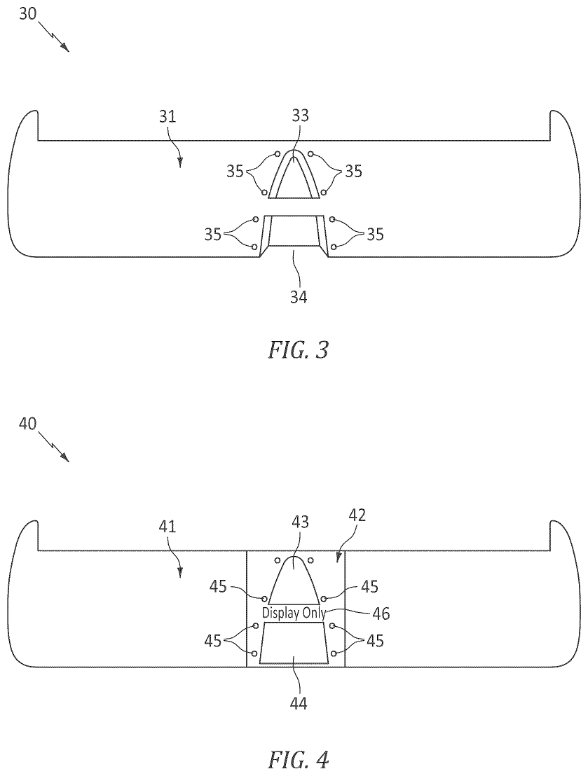

101-Acquiring a 3D data set. In this step, a component such as the exemplary horizontal aircraft stabilizer 30 of FIG. 3, for example, can be scanned to create a complete three-dimensional rendering. In one embodiment, a 3D scanner or scanning device 11 can be utilized to scan the component 30 from all sides and angles to create a complete 3D data set of the component. The 3D data set can be in any type of known file formats, such as OBJ, STL, IGES, VRML, AMF, PLY, or FBX, among others, for example.

Although illustrated with regard to a horizontal stabilizer 30, this is but one example, as any type and number of other components such as various flight surfaces, fairings, airframe members, engine components, landing gear, wheels, and brakes, among others can be scanned. Alternatively, the 3D data set can be obtained through external resources, such as the internet 17, for example, if such a complete 3D scan is available.

102—Adding a functional capacity blocker. In this step, the original 3D data set from step 101 can be modified to ensure the replica component produced by the inventive methodology described herein cannot be physically coupled to an aircraft. Such a step is critical, as the materials used to create the replica component are lightweight and non-structural, and thus would not be suitable for use on an aircraft as a true replacement for the scanned component.

In this regard, the original 3D data set from step 101 can be imported into a computer 16 on which a drafting/editing software such as AutoCAD®, for example, is located. The platform provider can then utilize the software to modify the file to include a functional capacity blocker such as an anti-mounting plate, for example, having a concave or angular surface that is positioned where the aircraft mounting elements of the original component are located.

For example, the exemplary horizontal stabilizer 30 of FIG. 3 includes the stabilizer body 31 having airframe mounting openings 33 and 34, along with a plurality of threaded apertures 35 that are used to receive mounting bolts to secure the device 30 onto an aircraft. As such, the replica component 40 of FIG. 4 that is produced by the inventive methodology will include a stabilizer body 41 that is substantially identical to the stabilizer body 31 except for the mounting elements 33-35 which are replaced by an angular anti-mounting plate/surface area 42.

In the preferred embodiment, markings 43-45 can be provided on the plate 41 to provide a visual representation of the original shape, size, and location of mounting elements 33-35, respectively, thus providing students with a visual understanding of how and where the real component would be secured onto an aircraft. Additionally, the platform provider can add instructions for certain portions of the replica component to be created in different colors to aid in a classroom environment. For example, the system can print the moving parts of the replica component in a first color (e.g., red) and the stationary parts of the replica component in a second color (e.g., green). Such a feature can assist students who will be handling the replica component in the classroom to immediately recognize moving or other sensitive areas of a component.

Although described as a plate that replaces the mounting elements of an aircraft component, it is to be understood that the functional capacity blocker can include, comprise or consist of any design element and/or structure that is provided on the replica component to make the replica component inoperable with or unmountable onto an aircraft. As such, it is preferred that the functional capacity blocker include an angular surface so as to ensure the component will not physically fit onto or couple to other aircraft components. Moreover, any number of other types of markings 46 such as “DISPLAY ONLY,” or “NOT AIRWORTHY,” for example, can be provided anywhere along the replica component and/or the plate itself to further ensure that the part is not and cannot be mounted onto an aircraft or attempted to be used in flight.

103—Storing the modified 3D data set. In this step, the modified 3D file(s) from step 3 can be stored in a database such as database 14, for example. In this regard, the database can function to store, index, and catalogue a plurality of modified design files/data sets. The database can include a search engine, menu, and/or any other type of searching and indexing configuration. Users can search the database using filters, keywords, or any other type of searching function to identify a desired replica component.

In one embodiment, access to the database can be for the exclusive use of the platform provider, who can create and ship the replica components produced by the system and method to end users such as universities or trade schools, for example. In one embodiment, access to the database can also be provided to the end users themselves, who can print the replica components on-site utilizing their own 3D printers. Such an option may be provided under a pay-per-use basis or via a subscription basis, for example.

104—Producing the replica 3D component. In this step, a user can download a desired 3D data set from the database utilizing a local computer and can send the file to a 3D printer to produce the downloaded replica component with the integrated functional capacity blocker, such as the replica horizontal stabilizer 40 of FIG. 4, for example. In most instances, the replica component will comprise a 1 to 1 full scale replica of the original component; however, some embodiments are contemplated wherein the end user can customize the scale.

For example, with large items such as flight surfaces, the user may choose to print 1 copy of the replica component at full scale for use by a classroom instructor and may also print several additional copies at a smaller scale (e.g., ¼ scale) for use by the students at their test bench. Of course, any number of other numbers and scales are also contemplated.

Accordingly, the above-described system and method provides replica aircraft components with functional capacity blockers for use in classroom environments that can be produced inexpensively and on-demand by universities to provide students with real world experience handling modern and up to date aircraft components in a manner not rendered obvious by any known art.

As to a further description of the manner and use of the present invention, the same should be apparent from the above description. Accordingly, no further discussion relating to the manner of usage and operation will be provided.

As described herein, one or more elements of the device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system, comprising:
a scanner that is configured to scan a first component and to produce a three dimensional data set of the first component;
a computer that is in communication with the scanner, said computer including functionality for receiving the three dimensional data set and for modifying the received three dimensional data set;
a database that is connected to the computer, said database functioning to receive the modified three dimensional data set from the computer; and
a three dimensional printer that is configured to print a replica component using the modified three dimensional data set.

2. The system of claim 1, wherein the scanner includes a three dimensional scanner.

3. The system of claim 1, wherein the modified three dimensional data set includes a functional capacity blocker.

4. The system of claim 1, wherein the three dimensional data set includes at least one mounting element found on the first component.

5. The system of claim 4, wherein the replica component includes a shape and a size that is identical to the first component.

6. The system of claim 5, wherein the replica component includes a functional capacity blocker at a location of each of the at least one mounting element.

7. A method, comprising:
acquiring a three dimensional data set of a first component;
storing the three dimensional data set on a first database;
modifying the three dimensional data set;
storing the modified three dimensional data set on a central database; and
creating a replica component based on the modified three dimensional data set.

8. The method of claim 7, wherein the modifying the three dimensional data set includes the steps of:
identifying a mounting element of the first component on the three dimensional data set; and
replacing the mounting element with a functional capacity blocker.
